(19) United States
(12) Patent Application Publication
(10) Pub. No.: US 2025/0257819 A1
(43) Pub. Date: Aug. 14, 2025

(54) SUBSEA SUPPORT APPARATUS AND ASSOCIATED METHODS

(71) Applicant: OneSubsea AS, Lysaker (NO)

(72) Inventor: Morten Rengman Moerck, Lysaker (NO)

(21) Appl. No.: 19/049,430

(22) Filed: Feb. 10, 2025

(30) Foreign Application Priority Data
Feb. 9, 2024 (GB) 2401818.6

(51) Int. Cl. F16L 3/16; E21B 43/01

(52) U.S. Cl. CPC F16L 3/16; E21B 43/0107

(57) ABSTRACT

A subsea line connector assembly with a subsea line having a subsea line connector portion. A host apparatus has a host connector portion for receiving the subsea line connector portion. A cantilever member connected to the host apparatus is configured to support a portion of a weight of the subsea line. The cantilever member has a proximal end at the host apparatus and a distal end spaced from the host apparatus. The subsea line is supported by the cantilever member at the distal end of the cantilever member.

### CROSS REFERENCE TO RELATED APPLICATION

This application claims priority to and benefit of GB patent application No 2401818.6, entitled “Subsea Support Apparatus and Associated Methods,” filed Feb. 9, 2024, which is herein incorporated by reference in its entirety.

### BACKGROUND

Flexible subsea lines such as umbilicals are longitudinal subsea links for providing passage of signals and or fluids to or between subsea locations. The signals can be control signals or instrumentation signals, such as for controlling subsea equipment or transmitting or transferring data or measurements from subsea equipment. Other signals can include power signals, such as for powering subsea equipment. Fluids contained or transported by umbilicals can include hydraulic fluids, such as for controlling subsea equipment; or chemicals for subsea processes (e.g. injection, kill, hydrate remediation, flushing, acid stimulation, etc.).

Typically an umbilical is a bundle of tubes and cables that provides hydraulic and/or electric power to subsea control systems. The umbilical often carries electric signals to and from subsea instrumentation and controls; and can be used to deliver chemicals for subsea injection at the subsea Xmas tree or downhole (e.g. can provide bulk methanol, gas for gas lift, etc.). An electrohydraulic subsea control umbilical typically supplies electrical power and multiplexed signal, hydraulics, and chemicals to one or more subsea control modules (SCMs) controlling subsea Xmas trees and/or other elements of a subsea production system. It can also carry signals from subsea instrumentation back to a control center.

A direct hydraulic control umbilical provides direct hydraulic control of each valve on a subsea Xmas tree, through a bundle of tubes from the topsides hydraulic power unit (HPU) to the subsea tree. Sometimes no electrical power or signal is required, with actuation of valves being via the supply of hydraulic power to the relevant tube. Such umbilicals are suited to subsea production systems with short offsets and few trees.

An electric power umbilical can supply large amounts of power (e.g. up to 100 KV), such as required to operate subsea boosting and processing systems. They may or may not include wires for multiplexed control systems and instrumentation, and tubes for hydraulics and chemical injection. Umbilicals are typically made with steel and/or thermoplastics, with the bundles typically wrapped or encased in a sheath. In some cases the umbilical can comprise a flowline. For example, integrated production umbilicals combine the umbilical function and the flowline. Such umbilicals can offer an alternative flow heating solution.

Umbilicals are typically terminated subsea with an umbilical termination head (UTH) connected at an umbilical termination assembly (UTA), which allows for the distribution of hydraulics, chemicals, and signals (electrical, instrumentation, power, fibre optic, etc.) through flying leads connecting the UTA to the subsea production system.

A subsea umbilical connection operation is generally performed by lowering the UTH until it is landed, typically using a guiding frame onto a porch or landing frame. The guiding frame is disconnected and the UTH is stroked towards a hub, often with a ROV tool. The UTH is generally secured, such as with a clamp, and a back-seal test is performed.

It may be an object of one or more aspects, examples, embodiments, or claims of the present disclosure to at least mitigate or ameliorate one or more problems associated with the prior art, such as those described herein or elsewhere.

### SUMMARY

According to an aspect there is provided a support for a subsea line, such as an umbilical, to support the subsea line at or proximal a connector. The support may comprise a cantilever member. The subsea line may comprise a subsea flexible line.

There may be provided a subsea line connector assembly. The subsea line connector assembly may comprise a subsea line. The subsea line may be an umbilical. The subsea line may comprise a subsea line connector portion. The subsea line connector assembly may comprise a host apparatus for receiving the subsea line. The host apparatus may comprise a host connector portion for receiving the subsea line connector portion.

The cantilever member may be connected to the host apparatus. The cantilever member may be configured to support a weight of the subsea line. The cantilever member may support the portion of the weight of the subsea line.

The cantilever member may comprise a proximal end. The proximal end may be attached at, connected to or formed with the host apparatus. The proximal end may comprise a fixed end of the cantilever member. The cantilever member may comprise a distal end. The distal end may be spaced from the host apparatus. The distal end may comprise a free end. The free end may be configured to deflect under the weight of the subsea line. The cantilever may be configured to deflect within its elastic bending range. The cantilever may be sized, dimensioned and of a material such that the cantilever member cannot plasticly deform under the weight of the subsea line.

The subsea line may be supported by the cantilever member at the distal end of the cantilever member. The subsea line may be supported by the cantilever member only at the distal end of the cantilever member.

Accordingly, in at least some examples, there is provided a subsea line connector assembly, the subsea line connector assembly comprising:
a subsea line, the subsea line comprising a subsea line connector portion; a host apparatus for receiving a subsea line, the host apparatus comprising a host connector portion for receiving the subsea line connector portion;
a cantilever member connected to the host apparatus, the cantilever member being configured to support a portion of a weight of the subsea line, the cantilever member having a proximal end at the host apparatus and a distal end spaced from the host apparatus;
wherein the subsea line is supported by the cantilever member at the distal end of the cantilever member.

Likewise, in at least some examples, there is provided a method of subsea line connection, the method comprising:
providing a subsea line connector assembly subsea, the subsea line connector assembly comprising:
a subsea line, the subsea line comprising a subsea line connector portion; a host apparatus for receiving a subsea line, the host apparatus comprising a host connector portion for receiving the subsea line connector portion;
a cantilever member connected to the host apparatus, the cantilever member having a proximal end at the host apparatus and a distal end spaced from the host apparatus;
receiving a subsea line connection portion of the subsea line with a host apparatus connection portion of the host apparatus;
   supporting a portion of a weight of the subsea line with the cantilever member at the distal end of the cantilever member.

The cantilever member may be configured to support at least a portion of the weight of the subsea line. The cantilever member may be configured to support only a portion of the weight of the subsea line. The cantilever member may be configured to support the portion of the weight of the subsea line during connecting of the subsea line to the host apparatus. Additionally or alternatively, the cantilever member may be configured to support the portion of the weight of the subsea line after connection of the subsea line to the host apparatus. The cantilever member may be configured to support the portion of the weight of the subsea line during use of the subsea line, such as whilst the subsea line is transporting signals and/or fluids therealong or therein. The cantilever member may support the portion of the weight of the subsea line during use of the subsea line. Additionally or alternatively, the cantilever member may support the portion of the weight of the subsea line during connecting of the subsea line to the host apparatus. The cantilever member may be configured to support the portion of the weight of the subsea line at or on the host apparatus. The cantilever member may be configured to support the portion of the weight of the subsea line at or on the host apparatus spaced from the host connector portion.

The cantilever member may be longitudinally oriented in a same longitudinal direction as the subsea line, at least in a horizontal plane. For example, when viewed from above, the subsea line and cantilever member may be longitudinally oriented in the same direction, extending away from the host apparatus. The cantilever member may support the subsea line at a point or position spaced from the host apparatus, such as spaced by a length of the cantilever member. The cantilever may support a portion of the weight of the subsea line such that that portion of weight is not borne by the host apparatus via the subsea line connection (e.g. the UTH). Accordingly, a force, such as a downwards force, exerted by the subsea line (e.g. the UTH) on the connector may be reduced. The portion of weight of the subsea line may be borne by the host apparatus via the cantilever member's attachment to the host apparatus. The cantilever member's attachment to the host apparatus may be spaced from the connection portion. Accordingly, a force/s associated with the connector portion/s (e.g. wherein connections, such as electric, hydraulic, fibre optic, etc. are for transfer between the subsea line and the host apparatus) may be reduced. Separating a portion of the weight of the subsea line borne by the host apparatus from the connector portion may reduce forces at or on the connector such as on contacts, seals or the like for transferring signals/fluids between the subsea line and the host apparatus.

The cantilever member may be laterally arranged. The cantilever member may be laterally arranged relative to the host apparatus. For example, the cantilever member may generally extend in a horizontal direction. In at least some examples, the cantilever member may extend horizontally in an unloaded configuration, such as prior to engagement with the subsea line. The unloaded cantilever member may extend in a more horizontal direction than the subsea line. For example, the host apparatus may be configured to receive the subsea line with the subsea line inclined downwards away from the host apparatus. An angle of inclination of the subsea line below the horizontal may be acute. The angle of inclination of the subsea line may reflect a sag of the subsea line. The subsea line may be negatively buoyant. For example, where the connector, such as the host connector portion, is inclined downwards, such as at an acute angle to accommodate a portion of weight of the subsea line, the cantilever may be less, or not, inclined downwards, at least in the unloaded configuration.

In at least some examples, the method comprises supporting the subsea line during connecting of the subsea line to the host apparatus such that the cantilever member acts as a guide member.

The cantilever member may comprise a beam. The beam may comprise a solid cross-section, such as a solid rectangular cross-section. In other examples, the beam may comprise a hollow cross-section, such as a hollow rectangular cross-section. The beam may comprise a shaped profile, such as a “I-”, “H-”, “L-”, “T-”, “C-” beam or the like. The cantilever member may comprise a continuous cross-section. The cantilever member may comprise a continuous cross-section along its entire length. Alternatively, the cantilever member may comprise a variable cross-section. The cantilever member may comprise a variable cross-section along its length. For example, the cantilever member may comprise a greater cross-sectional area at its end portion proximal to the host apparatus and a lesser cross-sectional area at its end portion distal to the host apparatus. The cantilever member may be configured to deflect under the weight of the portion of the subsea line. The cantilever member may be configured to deflect to a desired use position, the desired use position of the cantilever member supporting the subsea line, at least during use of the subsea line.

The cantilever may be configured relative to the subsea line, such as relative to a specific umbilical. For example, the cantilever may comprise a stiffness adapted for a weight and/or a stiffness of the subsea line. The cantilever may comprise a greater stiffness than the subsea line. In other examples, the cantilever member may comprise a stiffness equal to, or less than, the subsea line. The cantilever member may be configured to deflect a maximum deflection under maximum loading. The maximum loading may correspond to an in-use position of the subsea line, such as after completion of connection to the host apparatus. Alternatively, the maximum loading may correspond to a position of the subsea line during connection to the host apparatus. The cantilever member may be configured to deflect from an unloaded position to a loaded position. The distal, free end of the cantilever may deflect to a desired use position under loading. The loading may be associated with the subsea line weight. The cantilever member may be configured to deflect to a desired support position for the subsea line.

The cantilever member may form part of the host apparatus. For example, the cantilever member may be formed with the host apparatus. In at least some examples, the cantilever member may be permanently connected to or at the host apparatus. For example, the cantilever member may be welded to the host apparatus. In other examples, the cantilever member may be temporarily or detachably connected to the host apparatus. For example, the cantilever member may be attached to the host apparatus with fasteners, such as bolts, rivets, lock rings, pins, or the like. The cantilever member may become attached to the host apparatus subsea. For example, the cantilever member may be transported to the subsea location after the host apparatus; and attached to the host apparatus after the host apparatus has been positioned at a desired location. Transporting the cantilever member separately to the subsea location may be operationally efficient or expedient. For example, connecting the cantilever member to the host apparatus subsea may provide for a reduced footprint of the host apparatus during transportation and/or lifting and/or installation.

In at least some methods, the cantilever member may be connected to the host apparatus subsea. For example, the cantilever member may be welded or fastened to the host apparatus subsea, such as at a deployment location of the host apparatus (e.g. location of intended use of the host apparatus, such as proximal s subsea well, manifold, or the like). The method may comprise transporting the cantilever member to the subsea location separately or discretely from the host apparatus.

In at least some examples, the method may comprise retro-fitting the cantilever member to the host apparatus. For example, the method may comprise attaching the cantilever member to an historic or previously-installed host apparatus. The retrofitting may be prior to connection of a subsea line. Alternatively, the retrofitting may occur with a subsea line already connected. In at least some examples, the method may comprise providing additional support with the cantilever member to an already-connected umbilical. The method may comprise temporarily disconnecting the subsea line to attach the cantilever member and re-connecting the subsea line. The method may comprise attaching or retrofitting the cantilever member in advance of connection of a new or a replacement umbilical.

The cantilever member may comprise a contact portion for contacting the subsea line. The contact portion may be located at, near or on the distal end of the cantilever member. The contact portion may be spaced from the proximal end of the cantilever member.

The cantilever member may contact the subsea line only at the contact portion. The cantilever member may support the subsea line only at the contact portion.

The cantilever member may be positioned below the subsea line. Alternatively, the cantilever member may be positioned adjacent or alongside the subsea line, such as running parallel, or substantially parallel, laterally alongside the subsea line. The cantilever member may be connected to or with the subsea line by the contact portion. Particularly, but not exclusively, where the cantilever member is positioned adjacent or alongside the subsea line, the contact portion may comprise a cross element extending laterally from the cantilever member. The cross element may comprise a bar, sleeve, hoop, or portion thereof. For example, where the cantilever member is positioned adjacent or alongside the subsea line, the cross element may comprise a portion of a sleeve or hoop extending under the subsea line, for supporting the subsea line. The cross element may extend between a pair of cantilever members, such as a first cantilever member positioned on a left side of the subsea line and a second cantilever member positioned on a right side of the subsea line.

The contact portion may comprise a contact interface, between the subsea line and the cantilever member. The contact portion may comprise a contact point. The contact portion may comprise a contact area. The contact portion may be configured to support the subsea line. The contact portion may be configured to support the subsea line without deformation of the subsea line. For example, the contact portion may comprise an area such that the force/s associated with the cantilever member's support of the subsea line do not constitute a deformation stress in the subsea line. The contact portion may be configured to mitigate a stress concentration at or in the subsea line. The contact portion may comprise a rounded contact. The contact portion may comprise a radius/radii of at least a minimum radius.

The contact portion may comprise a low friction contact portion. The contact portion may be configured to allow the subsea line to translate relative to the cantilever member. The contact portion may be configured to allow or facilitate longitudinal movement of the subsea line relative to the cantilever member. For example, where the subsea line and the cantilever member are longitudinally oriented in a similar direction, at least in a horizontal plane, then the contact portion may be configured for relative translational movement between the subsea line and the cantilever member. The low friction contact portion may comprise a low sliding friction contact portion. For example, the coefficient of friction between the subsea line and the cantilever member may be low. The low friction contact portion may comprise a rolling contact. In at least some examples, the contact portion may comprise a wheel/s, roller/s, bearing/s or the like, for facilitating a rolling contact in a longitudinal direction of the subsea line/cantilever member.

The subsea line may be supported by the cantilever member only at the distal end of the cantilever member, such that the contact portion is only at the distal end of the cantilever member. Supporting the subsea line only at the distal end of the cantilever member may allow for relative movement between the subsea line and the cantilever member. For example, the cantilever member extending between the proximal end and the distal end may be able to bend, flex and/or extend, such as in response to the subsea line weight, at a different rate or angle from the subsea line. The subsea line may be separated from the cantilever member between the distal and proximal ends of the cantilever member. For example, where the cantilever member is located below the subsea line, the subsea line may be vertically separated or spaced above the cantilever member between the contact point at the distal end of the cantilever member and the proximal end of the cantilever member at or on the host apparatus. The subsea line may be separated from the cantilever member between the distal and proximal ends of the cantilever member when the cantilever member is loaded and/or unloaded. For example, the subsea line may be separated from the cantilever member between the distal and proximal ends of the cantilever member throughout connecting and use of the subsea line.

In at least some examples, the contact portion may comprise a link member/s. The link member may be connected to the subsea line at a first end of the link member. The link member may be connected to the cantilever member at a second end of the link member. The link member may be, or become, attached to the subsea line. The link member may be, or become, attached to the cantilever member. The link member may be pivotally or rotatably connected. The link member/s may be configured to provide an increased vertical separation between the subsea line and the cantilever member when the subsea line is in the connected position. The increased vertical separation may be relative to the separation between the subsea line and the cantilever member prior to and/or during connection of the subsea line to the host apparatus. The link member may comprise a link arm. The link member may comprise a pivot link. The pivot link may be configured to pivot the subsea line relative to the cantilever member during connection of the subsea line to the host apparatus. The pivoting may be in a portion of an arc. A centre of the arc may be defined by the link member's connection to or at the cantilever member. Accordingly, the link member may be configured to pivot the subsea line about the distal end of the cantilever member. The arc may be in a same plane as a longitudinal axis defined by the cantilever member and/or the subsea line, such as a vertical plane defined by the cantilever member and/or the subsea line. The link member may be configured to vary a vertical separation between the subsea line and the cantilever member, at least during connecting of the subsea line to the host apparatus. The link member may be configured to push the subsea line upwards relative to the cantilever member and the cantilever member downwards, during at least a portion of connecting the subsea line to the host apparatus. The link member may be configured to push the subsea line upwards relative to the cantilever member and the cantilever member downwards during connecting of the subsea line to the host apparatus.

In at least some examples, there is provided a subsea line connector assembly, the subsea line connector assembly comprising:
a subsea line, the subsea line comprising a subsea line connector portion; a host apparatus for receiving a subsea line, the host apparatus comprising a host connector portion for receiving the subsea line connector portion;
a longitudinal support member connected to the host apparatus, the longitudinal support member being configured to support a portion of a weight of the subsea line, the longitudinal support member having a proximal end at the host apparatus and a distal end spaced from the host apparatus;
wherein the subsea line is connected to the longitudinal support member by a link member.

Likewise, in at least some examples there is provided a method of subsea line connection, the method comprising:
providing a subsea line connector assembly subsea, the subsea line connector assembly comprising:
   a subsea line, the subsea line comprising a subsea line connector portion;
   a host apparatus for receiving a subsea line, the host apparatus comprising a host connector portion for receiving the subsea line connector portion; and
   a longitudinal support member connected to the host apparatus, the longitudinal support member having a proximal end at the host apparatus and a distal end spaced from the host apparatus;
receiving a subsea line connection portion of the subsea line with a host apparatus connection portion of the host apparatus;
connecting the subsea line to the longitudinal support member by a link member, the link member being connected to the subsea line at a first end of the link member and connected to the longitudinal support member at a second end of the link member;
pivoting the subsea line relative to the longitudinal support member using the link member during connecting of the subsea line to the host apparatus; and
connecting the subsea line to the host apparatus.

The longitudinal support member may be the cantilever member. The link member may be connected to the cantilever member at the distal end of the cantilever member.

The link member/s may be configured to mitigate against a lower elevation of the subsea line prior to connection. The link member/s may be configured to mitigate against the lower elevation of the subsea line prior to connection exerting an excessive force on the cantilever member. The subsea line may adopt or be positioned in or with a lower elevation. For example, the subsea line may be suspended and/or landed prior to connecting to the host apparatus, with the subsea line in a relatively lower position or elevation compared to after connection. The link member may be configured to protect the cantilever member from undesirable loading, such as being deflected to a lower position during connecting compared to a higher position for supporting the subsea line after the subsea line has been connected.

The host apparatus may comprise a guide element. The guide element may be configured to guide the subsea line connection portion into or onto the host apparatus connection portion, for connecting the subsea line to the host apparatus. The guide element may comprise a porch. Accordingly, the host apparatus may comprise a porch for receiving the subsea line and translationally guiding the subsea line relative to the host apparatus, for connection and/or disconnection of the subsea line thereto.

The cantilever member may support the subsea line when or whilst the subsea line is being connected with a lesser support than once or after the subsea line is connected. For example, the subsea line may be additionally or otherwise supported during connecting. At least the proximal end of the subsea line may be additionally or otherwise supported during connecting, such as by suspension, such as from an installation vessel thereabove, and/or on another support therebelow, such as a landing porch or frame. The cantilever member may support the subsea line during connecting such that an alignment tolerance may be reduced, such as relative to an alignment tolerance where no cantilever member support would be provided during connecting.

The host apparatus may comprise a subsea manifold or subsea template. The host apparatus may comprise an Umbilical Termination Assembly (UTA). The host apparatus may comprise one or more jumpers or leads, such as electrical and hydraulic flying leads. The host apparatus may comprise a Subsea Distribution Unit (SDU). The host apparatus may comprise a Subsea Control Module (SCM).

The subsea line may comprise a proximal end for connection to the host apparatus; and a distal end. The distal end may be remote from the host apparatus. The subsea line may comprise an intermediate portion between the proximal and distal ends. The subsea line may comprise an Umbilical Termination Head (UTH). The UTH may be at the proximal end. The UTH may be received on the porch.

The subsea line may comprise a flowline. The flowline may comprise umbilical flowline. The flowline may comprise a flexible flowline. The subsea line may comprise a longitudinal subsea links for providing passage of signals and/or fluids to or between subsea locations. The subsea line may comprise a direct hydraulic control umbilical. The subsea line may comprise an electric power umbilical.

In at least some examples, the subsea line may comprise a subsea line connecting the host apparatus subsea to a surface apparatus. The surface apparatus may comprise a static or fixed apparatus or structure, such as a rig, pipeline or the like. Alternatively, the surface apparatus may comprise a dynamic structure, such as a floating vessel, spar, FPSO, semi-submersible, or the like.

In other examples, the subsea line may connect the host apparatus subsea to another subsea apparatus.

The subsea line may comprise a static umbilical. Alternatively, the subsea line may comprise a dynamic umbilical.

The subsea line may comprise a bend restrictor or bend limiter. The bend restrictor or bend limiter may be at least partially supported by the cantilever member. In at least some examples, the cantilever member contacts the bend restrictor or bend limiter, thereby indirectly supporting the portion of the weight of the subsea line, the subsea line being directly supported by the bend restrictor or bend limiter.

The subsea line may comprise supplementary support/s. The supplementary support/s may at least partially support a portion of the weight of the subsea line. The supplementary support/s may at least partially support a portion of the weight of the subsea line. The supplementary support/s may comprise a buoyancy, such as distributed buoyancy. The subsea line may comprise the supplementary support/s at a portion spaced or remote from the subsea line portion supported by the cantilever member. For example, the supplementary support/s may be along an intermediate portion of the subsea line, such as between the host apparatus and surface. In at least some examples, the subsea line comprises a lazy wave configuration. In other examples, the subsea line comprises a catenary configuration.

In at least some examples, there may be provided a plurality of cantilever members. The plurality of cantilever members may be provided for a single umbilical. The plurality of cantilever members may be provided together, such as connected or touching. The plurality of cantilever members may combine to provide a greater total thickness and/or stiffness than a single cantilever member. For example, at least two cantilever members may be provided stacked one atop the other. Providing the plurality of cantilever members may enable a reduced inventory. For example, a single cantilever member be provided for a lighter (e.g. smaller diameter) umbilical, with two or more such cantilever members being provided for a relatively heavier (e.g. larger diameter) umbilical. Accordingly, inventory can be reduced for different umbilicals or locations; and/or support (e.g. stiffness) can be adapted or tailored. The plurality of cantilever members may be provided underneath the subsea line. Additionally or alternatively the plurality of cantilever members may be provided above or laterally of the subsea line. For example, where the cantilever member/s is/are provided laterally of the subsea line, such as running alongside the subsea line, there may be one or more cantilever members provided at each side of the subsea line (each at least one cantilever member on a left side and one cantilever member on a right side). Where a cantilever member is provided on top or above the subsea line, the cantilever member may be positioned or installed during or after umbilical connection. For example, the cantilever member may be positioned or installed after the subsea line has been landed, with the cantilever member being attached or repositioned to be above the subsea line to support the subsea line (e.g. by suspension).

Additionally or alternatively, the cantilever member may be adaptable. For example, the cantilever member may be configured to receive an additional component. The additional component may comprise a stiffener. The additional component may be permanently attached to the cantilever member, such as welded or adhered thereto. Alternatively, the additional component may be temporarily or detachably attached to the cantilever member, such as with fastener/s.

The support member may comprise a spring element. The support member may comprise a torsion element, such as a torsion spring. In at least some examples, the support member may comprise a beam pipe arranged as a torsion spring. The support member may provide an upwards support force to the subsea line provided by a torsional spring force of the torsion element, such as a beam pipe arranged as a torsion spring. The torsion element may connect a cantilever member to the host apparatus. The cantilever member may be connected to the host apparatus via the torsion element. In at least some examples, support and/or deflection and/or upwards force may be provided by a combination of torsion and/or cantilever support member/s. The torsion spring may enable use of a shorter cantilever member for an equivalent support and/or deflection and/or upwards force (e.g. equivalent to a cantilever member without a torsion spring, such as a similar cross-sectional cantilever member). The torsion spring may be arranged perpendicularly to the subsea line.

According to an aspect there is provided a system comprising the apparatus of any other aspect, example, embodiment or claim. The apparatus may comprise the structure or a component thereof, such as comprising a cantilever member and/or link member, of any other aspect, claims, embodiment or example.

According to an aspect, there is provided a method of using the apparatus, such as the cantilever member and/or link member and/or subsea line connector assembly, or portion/s thereof, according to an aspect, claim, embodiment or example of this disclosure.

The steps of the method may be in any order.

According to an aspect of, there is provided an apparatus configured to perform a method according to an aspect, claim, embodiment or example of this disclosure.

Within the scope of this disclosure it is expressly intended that the various aspects, embodiments, examples and alternatives set out in the preceding paragraphs, in the claims and/or in the following description and drawings, and in particular the individual features thereof, may be taken independently or in any combination. That is, all embodiments and/or features of any embodiment can be combined in any way and/or combination, unless such features are incompatible. The applicant reserves the right to change any originally filed claim or file any new claim accordingly, including the right to amend any originally filed claim to depend from and/or incorporate any feature of any other claim although not originally claimed in that manner.

### BRIEF DESCRIPTION

An embodiment of the present disclosure will now be described by way of example only and with reference to the accompanying drawings, in which:

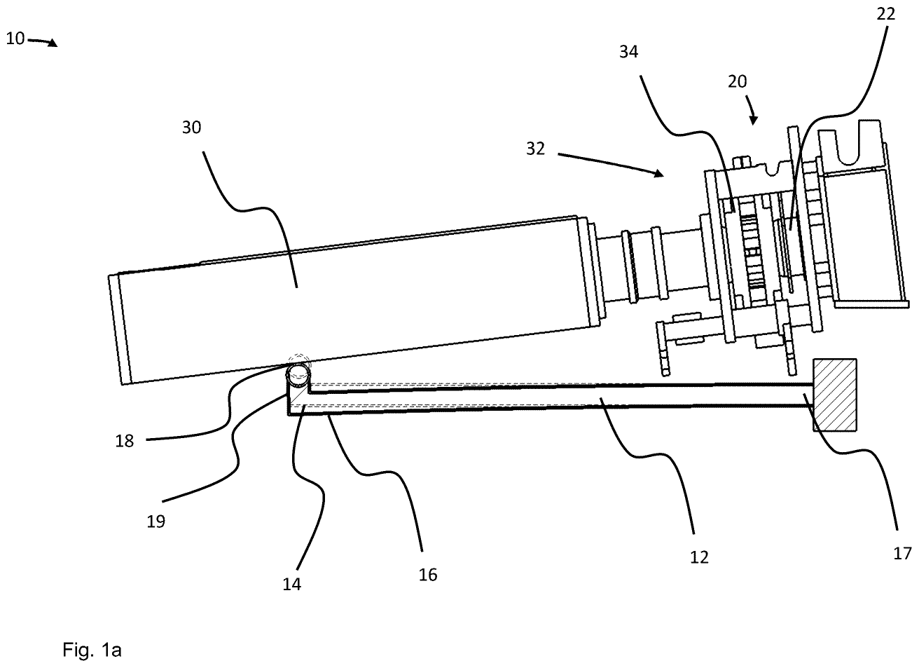

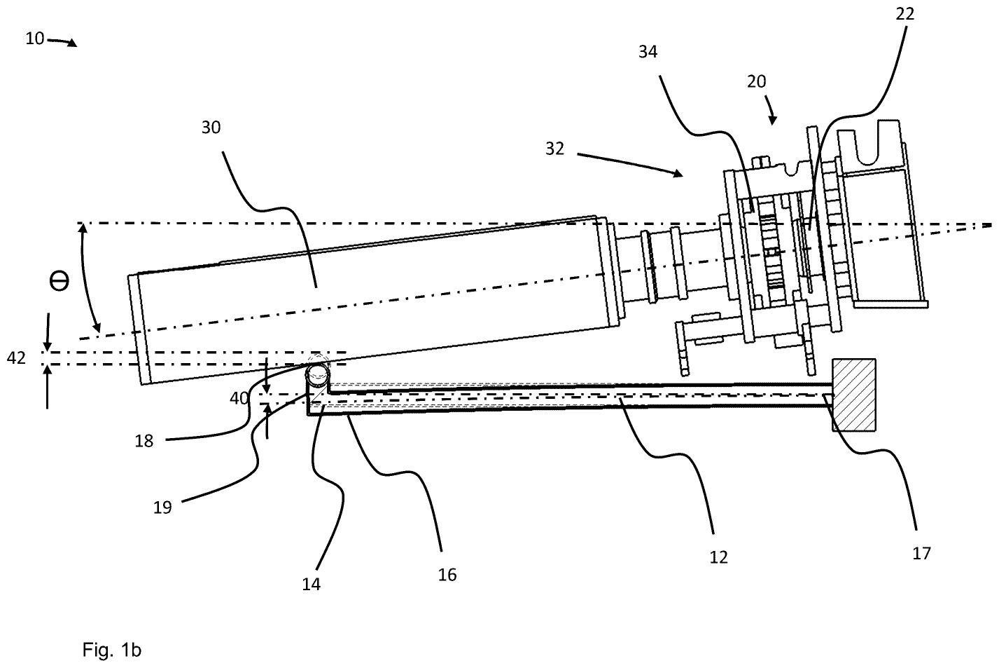

FIG. 1a shows an example of a subsea line connector assembly;

FIG. 1b shows an annotated version of the subsea line connector assembly of FIG. 1a;

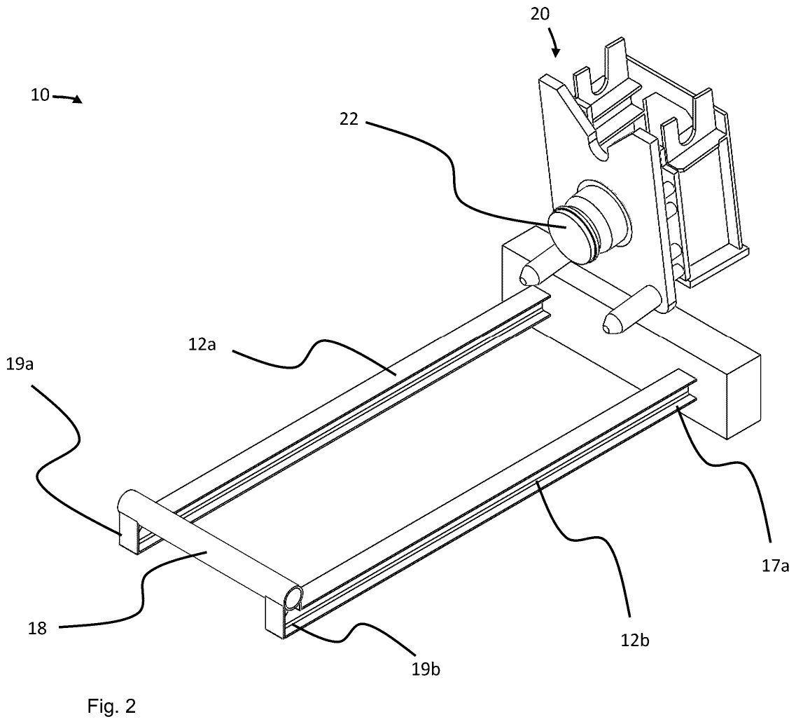

FIG. 2 shows a view of a possible embodiment of the example of FIG. 1a;

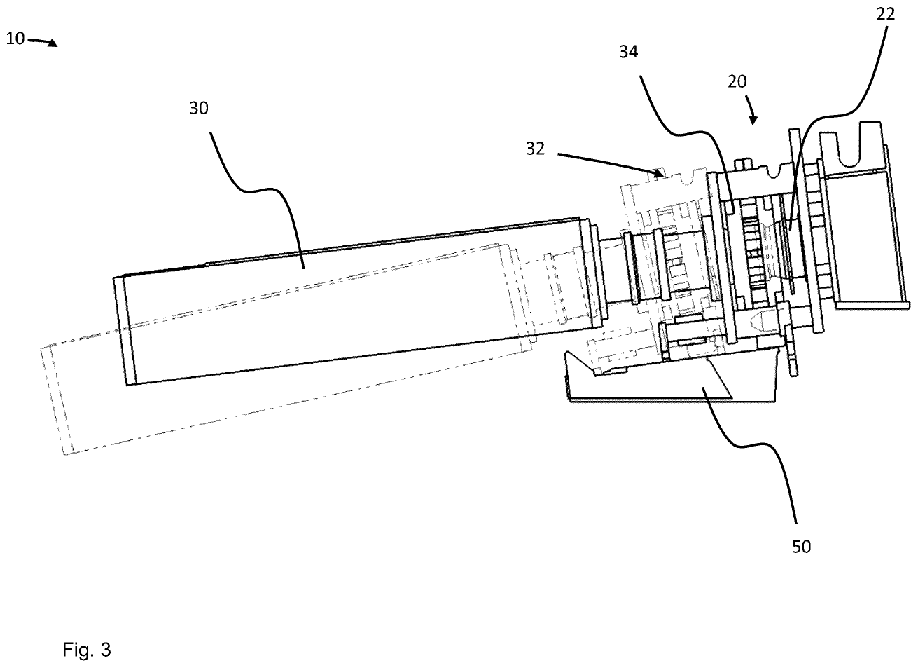

FIG. 3 shows the subsea line connector assembly of FIG. 1a with an example umbilical termination head at both the beginning (broken line) and end (solid line) of a connection operation;

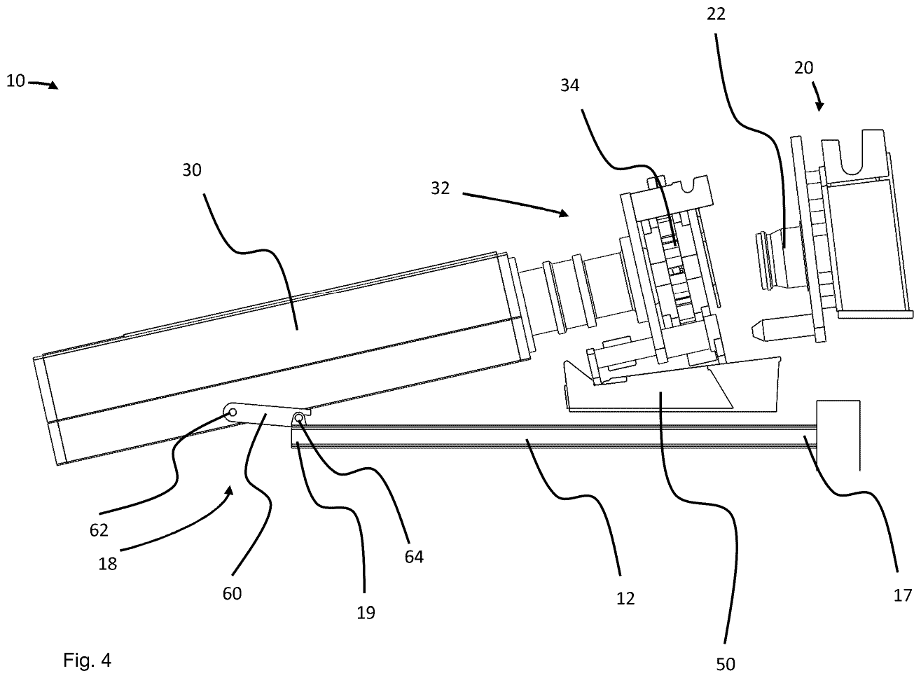

FIG. 4 shows another example of a subsea line connector assembly, shown here at a beginning of a connection operation;

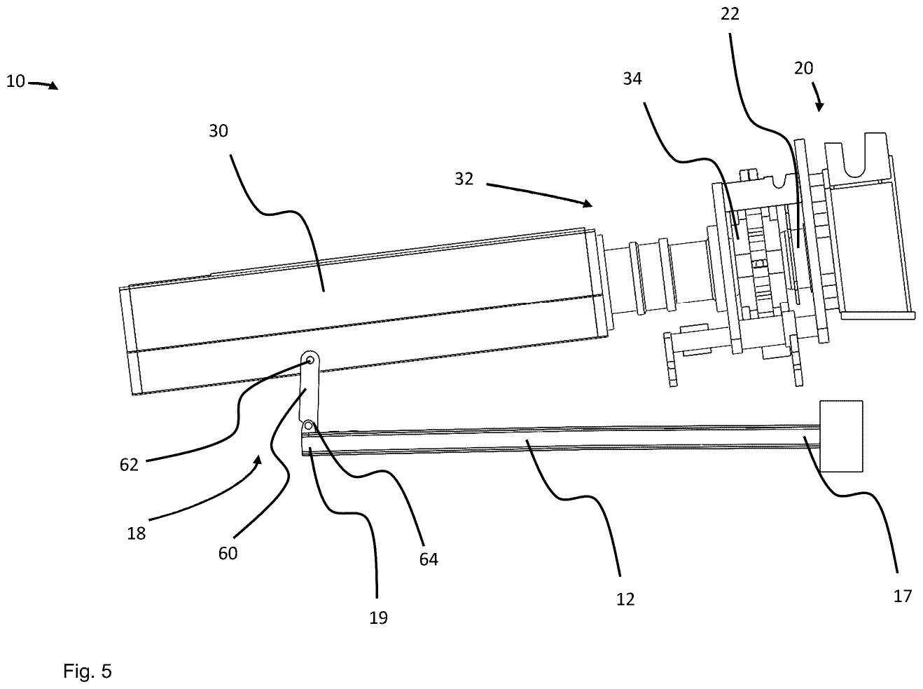

FIG. 5 shows the subsea line connector assembly at an end of or after completion of the connection operation;

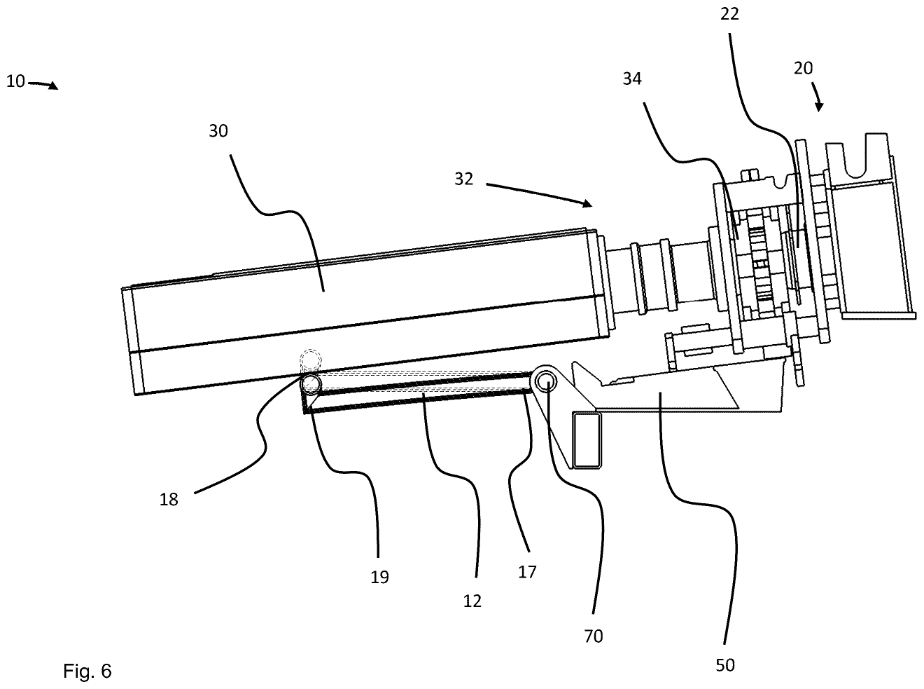

FIG. 6 shows another example of a subsea line connector assembly; and

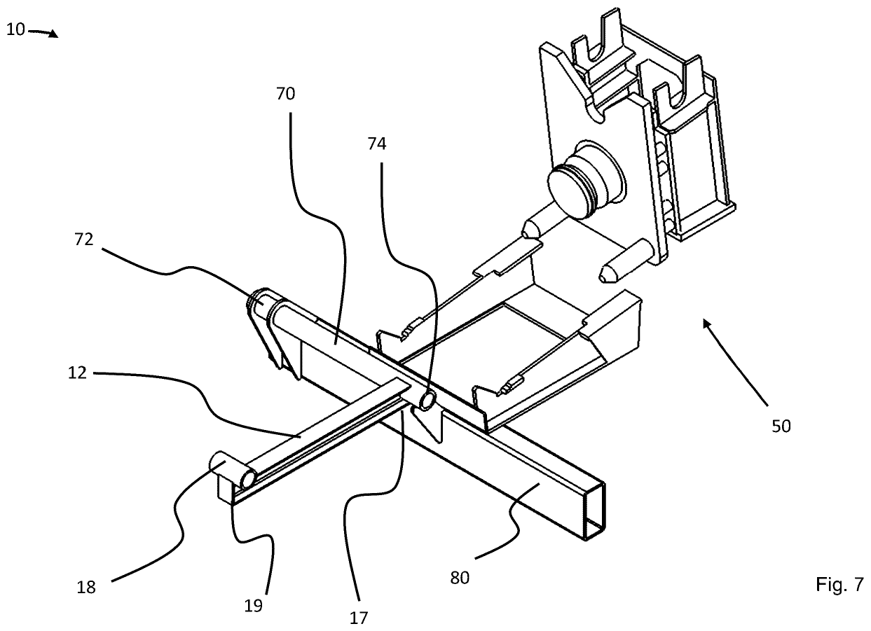

FIG. 7 shows the subsea line connector assembly of FIG. 6, without the subsea line.

### DETAILED DESCRIPTION

Referring firstly to FIG. 1a an example of a subsea line connector assembly, shown here in the form of a subsea umbilical connector assembly 10. FIG. 1b shows an annotated version of the subsea umbilical connector assembly 10 of FIG. 1a. FIG. 1a shows the cantilever member 12 in the form of a cantilever support beam, with the cantilever member 12 shown in broken line in an unloaded position 14; and in solid lines 16 with the cantilever member 12 deflected by an umbilical 30 with an Umbilical Termination Head (UTD) 32. The umbilical 30 comprises an umbilical connection portion 34.

The subsea umbilical 30 connector assembly comprises a host apparatus 20 for receiving the umbilical 30, the host apparatus 20 having a host connector portion 22 for receiving the umbilical connection portion 34.

The cantilever member 12 is connected to the host apparatus 20 and is configured to support a portion of the weight of the umbilical 30. The cantilever member 12 comprises a proximal end 17 attached at, connected to or formed with the host apparatus 20. The proximal end 17 defines a fixed end of the cantilever member 12. The cantilever member 12 comprises a distal end 19, spaced from the host apparatus 20. The distal end 19 comprises a free end and is configured to deflect under the weight of the umbilical 30. The cantilever member 12 is configured to deflect within its elastic bending range. The cantilever member 12 is sized, dimensioned and of a material such that the cantilever member 12 cannot plasticly deform under the portion of the weight of the umbilical 30. In the example show here, the cantilever member 12 is a steel beam. The umbilical 30 shown here is supported by the cantilever member 12 only at the distal end of the cantilever member 12. In this example, the cantilever member 12 has a length of around five times the diameter of the umbilical 30. For example, where the umbilical 30 has a diameter of 10 inches (25.4 cm), then the cantilever member 12 has a length of around 50 inches (127 cm).

The cantilever member 12 is configured to support only a portion of the weight of the umbilical 30. The cantilever member 12 is configured to support the portion of the weight of the umbilical 30 during connecting of the umbilical 30 to the host apparatus 20 and also after connection of the umbilical 30 to the host apparatus 20. The cantilever member 12 is configured to support the portion of the weight of the umbilical 30 during use of the umbilical 30, such as whilst the umbilical 30 is transporting signals and/or fluids therealong or therein. The cantilever member 12 is configured to support the portion of the weight of the umbilical 30 at or on the host apparatus 20 spaced from the host connector portion 22.

The cantilever member 12 is longitudinally oriented in a same longitudinal direction as the umbilical 30, at least in a horizontal plane. For example, when viewed from above (not shown), the umbilical 30 and cantilever member 12 are longitudinally oriented in the same direction, extending away from the host apparatus 20. The cantilever member 12 supports the umbilical 30 at a point or position spaced from the host apparatus 20, shown here spaced by a length of the cantilever member 12. Accordingly, the cantilever member 12 supports the portion of the weight of the umbilical 30 such that that portion of weight is not borne by the host apparatus 20 via the umbilical connection (e.g. the UTH 32). A downwards force, exerted by the umbilical 30 (e.g. the UTH 32) on the connector portion 22 is reduced. The portion of weight of the umbilical 30 is borne by the host apparatus 20 via the cantilever member's attachment to the host apparatus 20, which is spaced from the connection portion 22. Accordingly, forces associated with the connector portions 22, 34 (e.g. wherein connections, such as electric, hydraulic, fibre optic, etc. are for transfer between the umbilical 30 and the host apparatus 20) are reduced. Separating a portion of the weight of the umbilical 30 borne by the host apparatus 20 from the connector portion 22 reduces forces at or on the connector such as on contacts, seals or the like for transferring signals/fluids between the umbilical 30 and the host apparatus 20 (e.g. relative to where no support member 12 would be present).

The cantilever member 12 is laterally arranged relative to the host apparatus 20, with the cantilever member 12 generally extending in a horizontal direction in an unloaded configuration, such as prior to engagement with the umbilical 30 (shown by broken lines 14 in FIGS. 1a and 1b). The unloaded cantilever member 12 extends in a more horizontal direction than the umbilical 30, with the host apparatus 20 configured to receive the umbilical 30 with the umbilical 30 inclined downwards away from the host apparatus 20. An angle of inclination ⊖ of the umbilical 30 below the horizontal is acute. The angle of inclination ⊖ of the umbilical 30 reflects a sag of the umbilical 30, with the umbilical 30 being negatively buoyant. Here, where the host connector portion 22 is inclined downwards at an acute angle ⊖ to accommodate a portion of weight of the umbilical 30, the cantilever member 12 is less inclined downwards, at least in the unloaded configuration, shown in broken lines 14 in FIGS. 1a and 1b.

The cantilever member 12 here comprises a solid rectangular cross-section. In other examples, the beam comprises a hollow cross-section, such as a hollow rectangular cross-section, or with a shaped profile, such as a “I-,” “H-,” “L-,” “T-,” “C-” beam or the like. The cantilever member 12 here comprises a continuous cross-section along its entire length. In other examples (not shown here), the cantilever member 12 comprises a variable cross-section along its length, such as with a greater cross-sectional area at its end portion proximal to the host apparatus 20 and a lesser cross-sectional area at its end portion distal to the host apparatus 20.

The cantilever member 12 is configured to deflect, under the weight of the portion of the umbilical 30, to a desired use position, the desired use position of the cantilever member 12 supporting the umbilical 30, at least during use of the umbilical 30, as shown by the solid lines 16 of FIGS. 1a and 1b. The cantilever member 12 is configured relative to the umbilical 30, such as relative to a specific umbilical 30. For example, the cantilever member 12 comprises a stiffness adapted for a weight and/or a stiffness of the umbilical 30. Here, the cantilever member 12 comprises a greater stiffness than the umbilical 30. In other examples, the cantilever member 12 comprises a stiffness equal to, or less than, the umbilical 30. The cantilever member 12 is configured to deflect from an unloaded position to a loaded position, as shown in the transition from broken lines 14 to solid lines 16 in FIGS. 1a and 1b. The distal, free end of the cantilever member 12 deflects to a desired use position under the loading associated with the umbilical 30 weight, to support the umbilical 30. The cantilever member 12 is configured to deflect a maximum deflection under maximum loading, with the maximum loading corresponding to a position of the umbilical 30 during connection to the host apparatus 20. In the example shown in FIGS. 3 and 4, the maximum loading corresponds to an in-use position of the umbilical 30, after completion of connection to the host apparatus 20.

The cantilever member 12 here is permanently connected to the host apparatus 20, with the cantilever member 12 being welded to the host apparatus 20. In other examples, the cantilever member 12 is temporarily or detachably connected to the host apparatus 20, such as with fasteners. In this example, the cantilever member 12 has been transported to the subsea location after the host apparatus 20; and attached to the host apparatus 20 after the host apparatus 20 has been positioned at its desired location. Transporting the cantilever member 12 separately and connecting the cantilever member 12 to the host apparatus 20 subsea can provide for a reduced footprint of the host apparatus 20 during transportation, lifting and installation. In at least some examples, the method of installing comprises retro-fitting the cantilever member 12 to the host apparatus 20, such as to an historic or previously-installed host apparatus 20.

The cantilever member 12 comprises a contact portion 18 for contacting the umbilical 30. Here, the contact portion 18 is located at the distal end 19 of the cantilever member 12, spaced from the proximal end 17 of the cantilever member 12. The cantilever member 12 contacts and supports the umbilical 30 only at the contact portion 18. A deflection 40 of the cantilever member 12 corresponds to a lowering in height 42 of the contact portion 18 (as shown in FIG. 1b).

In the examples shown here, the cantilever member 12 is positioned below the umbilical 30. In other examples, the cantilever member 12 is positioned adjacent or alongside the umbilical 30, such as running parallel, or substantially parallel, laterally alongside the umbilical 30. The contact portion 18 comprises a contact interface, between the umbilical 30 and the cantilever member 12, with a contact area. The contact portion 18 is configured to support the umbilical 30 without deformation of the umbilical 30, with the example shown here having a contact portion 18 that comprises a sufficient area such that the forces associated with the cantilever member's support of the umbilical 30 do not constitute a deformation stress in the umbilical 30. The contact portion 18 here is configured to mitigate a stress concentration at or in the umbilical 30, with the contact portion 18 here comprising a rounded contact with a radius of at least a minimum radius. The contact portion 18 comprises a low friction contact portion 18, configured to allow the umbilical 30 to translate relative to the cantilever member 12. Here, where the umbilical 30 and the cantilever member 12 are longitudinally oriented in a similar direction, at least in a horizontal plane, then the contact portion 18 is configured for relative translational movement between the umbilical 30 and the cantilever member 12.

As shown here, the umbilical 30 is supported by the cantilever member 12 only at the distal end of the cantilever member 12, such that the contact portion 18 is only at the distal end of the cantilever member 12. Supporting the umbilical 30 only at the distal end of the cantilever member 12 allows for relative movement between the umbilical 30 and the cantilever member 12. For example, the cantilever member 12 extending between the proximal end 17 and the distal end 19 is able to bend in response to the umbilical 30 weight, at a different rate or angle from the umbilical 30. The umbilical 30 is separated from the cantilever member 12 between the distal and proximal ends 17, 19 of the cantilever member 12. Here, where the cantilever member 12 is located below the umbilical 30, the umbilical 30 is vertically separated or spaced above the cantilever member 12 between the contact portion 18 at the distal end 19 of the cantilever member 12 and the proximal end 17 of the cantilever member 12 at the host apparatus 20, when the cantilever member 12 is loaded and unloaded, throughout connecting and use of the umbilical 30.

It will be appreciated that a method of subsea umbilical connection can be achieved with the subsea umbilical connector assembly of FIGS. 1a and 1b.

Referring now to FIG. 2, there is shown a three-quarter view of a possible embodiment of the example of FIG. 1a. As shown here, there is a pair of cantilever members 12a, 12b positioned below and alongside the umbilical (not visible in FIG. 2), running parallel (at least when viewed from above) alongside the umbilical. The cantilever members 12a, 12b are connected with the umbilical by the contact portion 18 comprising a cross element extending laterally from each cantilever member 12a, 12b as shown here. The cross element 18 here comprises a round bar, extending under the umbilical, for supporting the umbilical. Accordingly, here the cross element extends between the pair of cantilever members 12a, 12b, respectively positioned on a left side of the umbilical and on a right side of the umbilical.

Referring now to FIG. 3, there is shown some of the subsea umbilical connector assembly 10 of FIG. 1a with an example umbilical termination head (UTH) 32 at both the beginning (broken line) and end (solid line) of a connection operation. For clarity, the cantilever member 12 has been omitted. The host apparatus 20 comprises a porch 50 configured to guide the umbilical connection portion 34 into the host apparatus connection portion 22, for connecting the umbilical 30 to the host apparatus 20. The porch 50 is for receiving the umbilical 30 and translationally guiding the umbilical 30 relative to the host apparatus 20, for connection and/or disconnection of the umbilical 30 thereto.

It will be appreciated that the flowline/UTH 30/32, when sitting on the porch 50 before stroking and make-up of the connector 10, will be sitting at a lower elevation than in its' final connected position, as illustrated with the broken line (before stroking) and solid line (after connection) in FIG. 3. Accordingly the weight of the UTH/termination 32 will be resting on the support member 12 (not shown in FIG. 3). Accordingly the termination 32 may need to sit in a certain position before the stroking or recovery can commence; or the load on the support member 12 itself may be required to support a greater load than would otherwise be required during use.

Referring now to FIG. 4, there is shown another example of a subsea umbilical connector assembly 12, shown at a beginning of a connection operation; and in FIG. 5 after the connection operation.

As shown here, the contact portion 18 comprises a link member 60. The link member 60 is connected to the umbilical 30 at a first end 62 of the link member 60 and to the cantilever member 12 at a second end 64 of the link member 60. The link member 60 here becomes attached to the cantilever member 12 subsea. The link member 60 is pivotally or rotatably connected and configured to provide an increased vertical separation between the umbilical 30 and the cantilever member 12 when the umbilical 30 is in the connected position (relative to prior to connection). The link member 60 here comprises a pivot link arm, configured to pivot the umbilical 30 relative to the cantilever member 12 during connection of the umbilical 30 to the host apparatus 20. The pivoting is in a portion of an arc, with a centre of the arc defined by the link member's connection to the cantilever member 12. Accordingly, the link member 60 pivots the umbilical 30 about the distal end 19 of the cantilever member 12 to vary a vertical separation between the umbilical 30 and the cantilever member 12, during connecting of the umbilical 30 to the host apparatus 20. The link member 60 is configured to push the umbilical 30 upwards relative to the cantilever member 12 and the cantilever member 12 downwards, during connecting the umbilical 30 to the host apparatus 20.

The link member 60 is configured to mitigate against a lower elevation of the umbilical 30 prior to connection, preventing an exertion of an excessive force on the cantilever member 12. Accordingly, the umbilical 30 can adopt or be positioned in or with a lower elevation (such as shown in broken lines in FIG. 2). For example, the umbilical 30 is suspended and landed prior to connecting to the host apparatus 20, with the umbilical 30 in a relatively lower position or elevation compared to after connection (shown in solid lines in FIG. 3). The link member 60 is configured to protect the cantilever member 12 from undesirable loading, such as being deflected to a lower position during connecting compared to a higher position for supporting the umbilical 30 after the umbilical 30 has been connected. Compared to the assembly 10 shown in FIGS. 1a and 1b, the link member 60 has effectively been added between the umbilical 30 and the contact portion 18 of the support member 12. The link member 60 is attached to, and allowed to rotate around, a shaft on the support member 12 or the umbilical 30. As shown here, when the two connection portions 22, 34 are stroked together, a free end of the link member 64 catches on a rod on the support member 12. As the stroking progresses, the link member 60 is forced to rotate, creating a distance between the umbilical 30 and the support member 12. As the stroking is complete, this distance results in the desired reaction force from the support member 12, as shown in FIG. 5. It will be appreciated that in at least some examples, a pair of link members 60 can be provided on either side of the umbilical 30. The pair of link members 60 can be connected to a single cantilever support member 12, such as also on either side of the cantilever member 12; or in some cases a pair of cantilever members 12 can be provided either side of the umbilical 30.

Accordingly, in at least some examples, the method comprises supporting the umbilical 30 during connecting of the umbilical 30 to the host apparatus 20 with the cantilever member 12. An example subsea umbilical connection operation can be performed by lowering the umbilical 30 with UTH 32 until it is landed, typically using a guiding frame onto the porch 50. The guiding frame is disconnected and the UTH 32 is stroked towards the host apparatus' connection portion 22, such as with a ROV tool. The UTH 32 is then secured, with a clamp, and a back-seal test is performed.

The host apparatus 20 here comprises an Umbilical Termination Assembly (UTA), with one or more jumpers or leads, such as electrical and hydraulic flying leads. In other examples, the host apparatus 20 comprises a Subsea Distribution Unit (SDU) or a Subsea Control Module (SCM).

The umbilical 30 comprises a proximal end for connection to the host apparatus 20; and a distal end. The distal end is remote from the host apparatus 20. The umbilical 30 comprises an intermediate portion between the proximal and distal ends. The umbilical 30 comprises an Umbilical 30 Termination Head (UTH). The UTH is at the proximal end. The UTH is received on the porch.

Referring now to FIGS. 6 and 7, there is shown another example of a subsea umbilical connector assembly 12. Here, the support member comprises a beam pipe arranged as a torsion spring 70. The cantilever member 12 is connected to the host apparatus 20 via the torsion spring 70. The support member provides an upwards support force to the umbilical 30 by a torsional spring force of the torsion spring 70. As shown here, support, deflection and upwards force is provided by a combination of the torsion and cantilever support members 12, 70. Here, most of the flexibility for deflection is provided by the torsion spring 70, with the cantilever member 12 providing relatively little deflection due to flexion/deformation of the cantilever member 12 as such. The cantilever member 12 here serves primarily to provide a lever for the torsion spring 70, about which the umbilical 30 can rotate.

As shown in FIG. 7, the torsion spring 70 is a beam pipe arranged as a torsion bar. A first end 72 of the torsion spring 70 is rigidly fixed to the host apparatus 20. As shown here, the torsion spring 70 is welded at its first end 72 to a support bracket attached to a structural beam 80 of the host apparatus 20. A second end 74 of the torsion spring 70 is free. As shown in FIG. 7, the free end 74 of the torsion spring 70 can rotate about a longitudinal axis of the torsion spring 70. In this particular example, the free end 74 of the torsion spring 70 is supported from underneath, with the free end 74 resting upon a bracket. The free end 74 can rotate on the bracket. The torsion spring 70 is arranged perpendicularly to the umbilical 30. The cantilever member 12 is rigidly attached to the free end 74 of the torsion spring 70. Accordingly, the cantilever member 12 is free to rotate with the free end 74 of the torsion spring 70 (e.g. under the weight of the umbilical 30).

The torsion spring 70 can enable use of a shorter cantilever member 12 for an equivalent support, deflection or upwards force (e.g. equivalent to a cantilever member 12 without a torsion spring, such as a similar cross-sectional cantilever member). For example, the cantilever member 12 shown in FIG. 6 is shorter than that 12 shown in FIG. 1a.

In at least some examples, the umbilical 30 comprises an umbilical 30 connecting the host apparatus 20 subsea to a surface apparatus. The surface apparatus comprises a static or fixed apparatus or structure, such as a rig, pipeline or the like. In other examples, the surface apparatus comprises a dynamic structure, such as a floating vessel, spar, FPSO, semi-submersible, or the like. In other examples, the umbilical 30 connects the host apparatus 20 subsea to another subsea apparatus.

It will be appreciated that, although shown in examples here with an exemplary umbilical 30, in other examples other subsea lines such as flexible flowlines may be similarly supported.

It will be appreciated that, although schematic, the relative proportions of the elements shown are shown to scale with the other elements shown. Accordingly, the schematic depictions provide an accurate indication of relative parameters, such as relative thicknesses, lengths, etc.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings), may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of any foregoing embodiments. The invention extends to any novel one, or any novel combination, of the features disclosed in this specification (including any accompanying claims, abstract and drawings), or to any novel one, or any novel combination, of the steps of any method or process so disclosed. The claims should not be construed to cover merely the foregoing embodiments, but also any embodiments, which fall within the scope of the claims, including with equivalence.

1. A subsea line connector assembly, the subsea umbilical connector assembly comprising:
a subsea line, the subsea line comprising a subsea line connector portion;
a host apparatus for receiving a subsea line, the host apparatus comprising a host connector portion for receiving the subsea line connector portion; and
a cantilever member connected to the host apparatus, the cantilever member being configured to support a portion of a weight of the subsea line, the cantilever member having a proximal end at the host apparatus and a distal end spaced from the host apparatus;
wherein the subsea line is supported by the cantilever member at the distal end of the cantilever member.

2. The subsea umbilical connector assembly of claim 1, wherein the subsea line is supported by the cantilever member only at the distal end of the cantilever member.

3. The subsea umbilical connector assembly of claim 1, wherein the cantilever member is configured to support the portion of the weight of the subsea line during connecting of the subsea line to the host apparatus; and additionally during use of the subsea line thereafter.

4. The subsea umbilical connector assembly of claim 1, wherein the cantilever member is configured to support the portion of the weight of the subsea line at or on the host apparatus spaced from the host connector portion.

5. The subsea umbilical connector assembly of claim 1, wherein the cantilever member is longitudinally oriented in a same longitudinal direction as the subsea line, at least in a horizontal plane.

6. The subsea umbilical connector assembly of claim 1, wherein the cantilever member is laterally arranged, with the cantilever member generally extending in a horizontal direction in an unloaded configuration, prior to engagement with the subsea line.

7. The subsea umbilical connector assembly of claim 1, wherein the unloaded cantilever member extends in a more horizontal direction than the subsea line, the host apparatus being configured to receive the subsea line with the subsea line inclined downwards away from the host apparatus.

8. The subsea umbilical connector assembly of claim 1, wherein the cantilever member comprises a beam, selected from one or more of: a solid cross-section, a solid rectangular cross-section, a hollow cross-section, a hollow rectangular cross-section, a shaped profile, a “I-beam,” “H-beam,” “L-beam,” “T-beam,” “C-beam.”

9. The subsea umbilical connector assembly of claim 1, wherein the cantilever member is at least one of the following:
a. configured to deflect under the weight of the portion of the subsea line, with the cantilever comprising a stiffness adapted for a weight of the subsea line;
b. connected to the host apparatus via a torsion element;
c. permanently connected to or at the host apparatus, such as welded to the host apparatus; or
d. temporarily or detachably connected to the host apparatus.

10. The subsea umbilical connector assembly of claim 1, wherein the cantilever member:
a. becomes attached to the host apparatus subsea; or
b. supports the subsea line only at a contact portion of the cantilever member, the contact portion being located at, near or on the distal end of the cantilever member and being spaced from the proximal end of the cantilever member.

11. The subsea umbilical connector assembly of claim 1, wherein the contact portion comprises a low friction contact portion, configured to allow the subsea line to translate relative to the cantilever member.

12. The subsea umbilical connector assembly of claim 11, wherein the low friction contact portion comprises at least one of: a sliding friction contact portion, and a rolling contact portion.

13. The subsea umbilical connector assembly of claim 1, wherein the contact portion comprises a link member connected to the subsea line at a first end of the link member and connected to the cantilever member at a second end of the link member, with the link member being configured to pivot the subsea line relative to the cantilever member during connection of the subsea line to the host apparatus.

14. The subsea umbilical connector assembly of claim 1, wherein there is provided a plurality of cantilever members.

15. A method of subsea umbilical connection, the method comprising:
providing a subsea umbilical connector assembly subsea, the subsea umbilical connector assembly comprising:
a subsea line, the subsea line comprising a subsea line connector portion;
a host apparatus for receiving a subsea line, the host apparatus comprising a host connector portion for receiving the subsea line connector portion; and
a cantilever member connected to the host apparatus, the cantilever member having a proximal end at the host apparatus and a distal end spaced from the host apparatus;
receiving a subsea line connection portion of the subsea line with a host apparatus connection portion of the host apparatus;
supporting a portion of a weight of the subsea line with the cantilever member at the distal end of the cantilever member; and
connecting the subsea line to the host apparatus.

16. The method of subsea umbilical connection of claim 15, wherein the cantilever member supports the subsea line such that the portion of weight of the subsea line is borne by the host apparatus via the cantilever member's attachment to the host apparatus.

17. The method of subsea umbilical connection of claim 15, further comprising supporting the subsea line during connecting of the subsea line to the host apparatus.

18. The method of subsea umbilical connection of claim 15, further comprising transporting the cantilever member to a subsea location for installation after the host apparatus; and attaching the cantilever member to the host apparatus subsea after the host apparatus has been positioned at a desired location.

19. The method of subsea umbilical connection of claim 15, further comprising retro-fitting the cantilever member to the host apparatus.

20. A subsea umbilical connector assembly, the subsea umbilical connector assembly comprising:
a subsea line, the subsea line comprising a subsea line connector portion;
a host apparatus for receiving a subsea line, the host apparatus comprising a host connector portion for receiving the subsea line connector portion; and
a longitudinal support member connected to the host apparatus, the longitudinal support being configured to support a portion of a weight of the subsea line, the longitudinal support member having a proximal end at the host apparatus and a distal end spaced from the host apparatus;
wherein the subsea line is connected to the longitudinal support member by a link member, the link member being connected to the subsea line at a first end of the link member and connected to the longitudinal support member at a second end of the link member, with the link member being configured to pivot the subsea line relative to the longitudinal support member during connecting of the subsea line to the host apparatus.
